(19) United States
(12) Patent Application Publication
(10) Pub. No.: US 2009/0022317 A1
(43) Pub. Date: Jan. 22, 2009

(54) VEHICLE SECURITY SYSTEM

(75) Inventors: Isao AKIMA, Ogaki (JP); Tatsuya HARA, Chino (JP); Eiji NATORI, Chino (JP); Kazuo TANAKA, Ina (JP); Masahiro TAKEUCHI, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/169,086

(22) Filed: Jul. 8, 2008

(30) Foreign Application Priority Data
Jul. 20, 2007 (JP) 2007-189155

(51) Int. Cl. H04L 9/06

(52) U.S. Cl. 380/277

(57) ABSTRACT

A vehicle security system includes a reception device that is mounted on a vehicle, and a transmission device that remotely operates the vehicle. The transmission device includes an encryption section that encrypts identification information that identifies the transmission device with a first encryption key, and a transmission section that transmits to the reception device instruction information that includes the identification information encrypted and gives an operation instruction to the reception device. The reception device includes a FeRAM that stores a second encryption key to pair with the first encryption key, wherein the second encryption key is erased from the FeRAM when the second encryption key is read out from the FeRAM, a reception section that receives the instruction information transmitted from the transmission device, a decoding section that decodes the identification information received, which is encrypted with the first encryption key and included in the received instruction information, with the second encryption key that is supposed to be stored in the FeRAM, and a judgment section that judges based on the decoded identification information as to whether the transmission device matches with the reception device.

The entire disclosure of Japanese Patent Application No. 2007-189155, filed Jul. 20, 2007 is expressly incorporated by reference herein.

### BACKGROUND

1. Technical Field

The present invention relates to vehicle security systems.

2. Related Art

Cryptographic technology has been used to prevent leak of classified data. A variety of methods are available in cryptographic technology. When data is encrypted or decoded, encryption keys for controlling the procedure of encryption algorithm are required. For example, in the case of a security system for vehicles described in JP-A-08-170457, encrypted data transmitted from a transmitter is received by a receiver mounted on a vehicle, and the encrypted data received is decoded by using an encryption key. In the case of vehicle security systems in related art, for example, encryption keys may often be stored in an electrically rewritable nonvolatile memory, such as, for example, an EEPROM (electrically erasable programmable read-only memory), a flash memory or the like.

However, when encryption keys are stored in a nonvolatile memory, such as, an EEPROM, a flash memory or the like, as in the vehicle security system in related art described above, unauthorized users with malicious intention may read out the encryption keys. Then, a transmitter device may be counterfeited based on the encryption keys read out, and there is a possibility that the vehicle may be illegally operated by the transmission device.

### SUMMARY

In accordance with an advantage of some aspects of embodiments of the invention and application examples to be described below, a solution to at least a part of the problems described above can be provided.

In accordance with an embodiment of the invention, a vehicle security system includes a reception device that is mounted on a vehicle, and a transmission device that remotely operates the vehicle. The transmission device includes an encryption section that encrypts identification information that identifies the transmission device with a first encryption key, and a transmission section that transmits to the reception device instruction information that includes the identification information encrypted and gives an operation instruction to the reception device. The reception device includes a FeRAM that stores a second encryption key to pair with the first encryption key, wherein the second encryption key is erased from the FeRAM when the second encryption key is read out from the FeRAM, a reception section that receives the instruction information transmitted from the transmission device, a decoding section that decodes the identification information received, which is encrypted with the first encryption key and included in the received instruction information, with the second encryption key that is supposed to be stored in the FeRAM, and a judgment section that judges based on the decoded identification information as to whether the transmission device matches with the reception device.

According to the vehicle security system described above, in the transmission device, the encryption section encrypts identification information with a first encryption key, and the transmission section transmits to the reception device instruction information including the encrypted identification information. In the reception device, the reception section receives the transmitted instruction information, and the decoding section decodes the identification information included in the received instruction information with the second encryption key that pairs with the first encryption key. The second encryption key is stored in the FeRAM, and erased if it is read out from the FeRAM. As the second encryption key is erased when it is read out, the decoding section cannot decode encrypted identification information identifying the transmission device with the second encryption key after it is erased. Therefore, if unauthorized users with malicious intention read out the second encryption key, and illegally create a transmission device having the first encryption key based on the second encryption key read out, encrypted identification information sent from the transmission device cannot be decoded by the reception device. Accordingly, the unauthorized users with malicious intention cannot operate the vehicle by illegally operating the reception device mounted on the vehicle.

In accordance with an aspect of the embodiment of the invention, the instruction information transmitted from the transmission device may include control information for controlling the vehicle on which the reception device is mounted, and the reception device may further include a vehicle control section that controls the vehicle. When the judgment section judges that the transmission device matches with the reception device, the vehicle control section controls the vehicle based on the control information included in the instruction information received by the reception section.

According to the vehicle security system described above, upon judging that the transmission device matches with the reception device, the vehicle control section controls the vehicle based on the control information included in the instruction information. Therefore, even when unauthorized users with malicious intention illegally create a transmission device, the transmission device is judged not to match with the reception device. Accordingly, the unauthorized users with malicious intention can be prevented from illegally controlling and operating the vehicle.

In accordance with an aspect of the embodiment of the invention, the control information may be information to control a door lock on the vehicle.

According to the vehicle security system described above, the control information is information to control door locks on the vehicle, such that unauthorized users with malicious intention can be prevented from locking and unlocking the door locks on the vehicle.

In accordance with an aspect of the embodiment of the invention, the control information may be information to control starting of an engine of the vehicle.

According to the vehicle security system described above, the control information is information to control starting of an engine of a vehicle, such that unauthorized users with malicious intention can be prevented from starting the engine of the vehicle.

In accordance with another embodiment of the invention, a vehicle security system includes a reception device that is mounted on a vehicle, and an immobilizer key to be inserted in the vehicle. The immobilizer key includes a storage section that stores encrypted identification information for identifying the immobilizer key. The reception device includes a FeRAM that stores an encryption key, wherein the encryption key is erased from the FeRAM when the encryption key is read out from the FeRAM, an acquiring section that acquires the encrypted identification information from the storage section of the immobilizer key, a decoding section that decodes the acquired encrypted identification information with the encryption key that is supposed to be stored in the FeRAM, and a judgment section that judges based on the decoded identification information as to whether the immobilizer key matches with the reception device.

According to the vehicle security system described above, in the transmission device, the acquiring section acquires the encrypted identification information of the immobilizer key from the storage section of the immobilizer key, and the decoding section decodes the acquired identification information with the encryption key. The encryption key is erased when it is read out. Therefore, after the encryption key is erased, the decoding section cannot decode encrypted identification information for identifying the immobilizer key by using the encryption key. Therefore, if unauthorized users with malicious intention read out the encryption key, and illegally create an immobilizer key based on the encryption key read out, the encrypted identification information of the immobilizer key cannot be decoded by the reception device. Accordingly, the unauthorized users with malicious intention cannot operate the vehicle by illegally operating the reception device mounted on the vehicle.

### BRIEF DESCRIPTION OF THE DRAWINGS

FIG. 1 is a schematic illustration of an example of a vehicle security system in accordance with an embodiment of the invention.

FIG. 2 is a block diagram of functional compositions of a reception device mounted on a vehicle and a remote control key.

FIG. 3 is a schematic diagram of a memory cell composing a FeRAM.

FIG. 4 is a flowchart of operations of the reception device and the remote control key.

FIG. 5 is a schematic illustration of an immobilizer key for starting an engine of a vehicle and a key cylinder in accordance with a second embodiment of the invention.

FIG. 6 is a block diagram of functional compositions of a reception device mounted on a vehicle and an immobilizer key.

FIG. 7 is a flowchart of operations of the reception device and the immobilizer key.

### DESCRIPTION OF EXEMPLARY EMBODIMENTS

### First Embodiment

A vehicle security system in accordance with a first embodiment of the invention is described below with reference to the accompanying drawings.

Vehicle and Remote Control Key

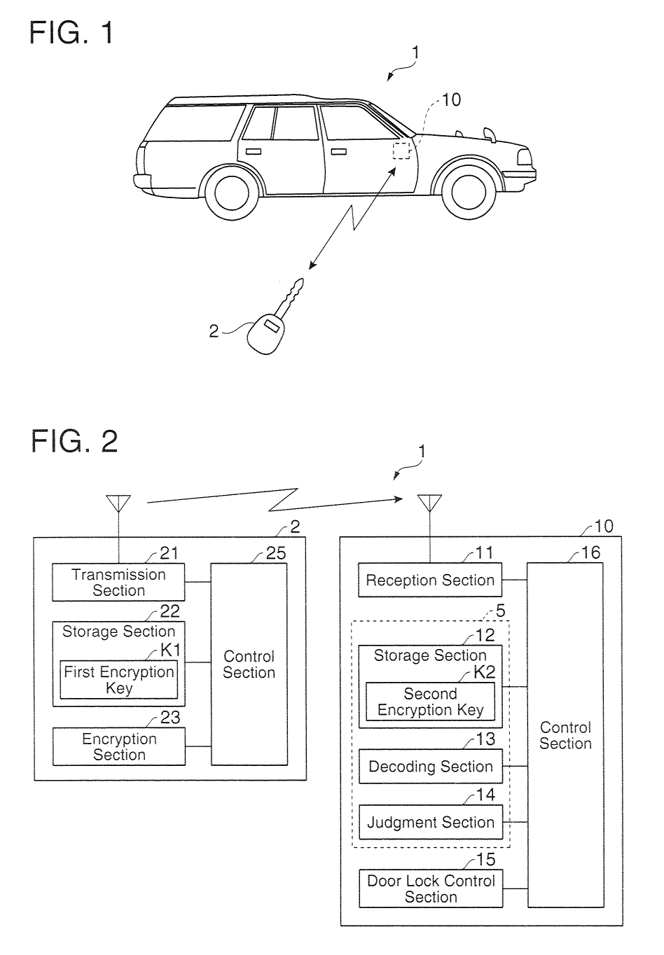

FIG. 1 is a schematic illustration of an example of the vehicle security system in accordance with the first embodiment of the invention. As illustrated in the figure, the vehicle security system in accordance with the example of the present embodiment is formed from a reception device 10 mounted on a vehicle 1, and a remote control key 2 as a transmission device. The user holds the remote control key 2 and remotely controls the vehicle 1. The vehicle 1 is in a stopped state, and the engine on the vehicle 1 is also in a stopped state.

Functional Structure of Reception Device and Remote Control Key

FIG. 2 is a block diagram of functional structure of the reception device 10 installed on the vehicle 1 and the remote control key 2. As shown in the drawing, the reception device 10 includes a reception section 11, a storage section 12, a decoding section 13, a judgment section 14, a door lock control section 15 as a vehicle control section, and a control section 16. The remote control key 2 includes a transmission section 21, a storage section 22, an encryption section 23 and a control section 25. Also, the storage section 12 of the reception section 10 stores a second encryption key K2, and the storage section 22 of the remote control key 2 stores a first encryption key K1.

The storage section 12, the decoding section 13 and the judgment section 14 of the reception device 10 require rewriting and storing capability, and may be formed from a FeRAM (ferroelectric random access memory) 5 having tamper proofness. It is noted that not all of the storage section 12, the decoding section 13 and the judgment section 14 may be composed of a FeRAM 5, but at least the second encryption key K2 stored in the storage section 12 may be formed from the FeRAM 5. The FeRAM 5 shall be described in detail below.

Next, functions of the reception device 10 are described. The reception section 11 of the reception device 10 receives a signal on infrared ray or radio wave as instruction information. The instruction information includes encrypted identification information that identifies the remote control key 2, and control information that controls the vehicle 1.

The decoding section 13 of the reception device 10 uses the second encryption key K2 stored in the storage section 12, thereby decoding the encrypted identification information included in the instruction information received by the reception section 11.

The judgment section 14 of the reception device 10 judges, based on the identification information of the remote control key 2 decoded by the decoding section 13, as to whether the remote control key 2 can match with the reception device 10. Here, hash values of the decoded identification information of the remote control key 2 and the identification information stored in the ROM of the control section 16 (to be described below) are calculated, and the two hash values are compared to make the judgment.

The door lock control section 15 of the reception device 10 locks or unlocks the door lock on the vehicle 1 based on control information contained in the received instruction information when the judgment section 14 judges that the remote control key 2 can match.

The control section 16 of the reception device 10 is equipped with CPU, ROM, RAM and the like (not shown), and controls each of the aforementioned reception section 11, the storage section 12, the decoding section 13, the judgment section 14 and the door lock control section 15.

Next, functions of the remote control key 2 are described. The transmission section 21 of the remote control key 2 transmits to the vehicle 1 signals of instruction information containing encrypted identification information and control information.

The encryption section 23 of the remote control key 2 encrypts identification information in a plaintext that identifies the remote control key 2, using the first encryption key K1 stored in the storage section 22. The first encryption key K1 pairs with the second encryption key K2 stored in the storage section 12 of the reception device 10, and the identification information encrypted with the first encryption key K1 can be decoded with the second encryption key K2.

The control section 25 of the remote control key 2 is equipped with unshown CPU, ROM, RAM and the like, and controls each of the aforementioned transmission section 21, the storage section 22 and the encryption section 23.

Identification information in a plaintext that identifies the remote control key 2 is stored in the ROM of the control section 25. Control information for controlling the vehicle 1 is generated by the control section 25 in response to operations of the operation buttons (not shown) and the like depressed by the user.

Structure of Storage Section

Next, the FeRAM 5 for the vehicle 1 is described. The FeRAM 5 is comprised of memory cells formed from ferroelectric material, and is a memory in which the ferroelectric material is used in capacitors for data retention. Here, the ferroelectric film has spontaneous polarization and has a property in which its polarization direction reverses according to the direction of an applied electric field. The FeRAM 5 uses the polarization inversion for memory retention. Also, the FeRAM 5 is a nonvolatile memory that does not require electrical power to retain data.

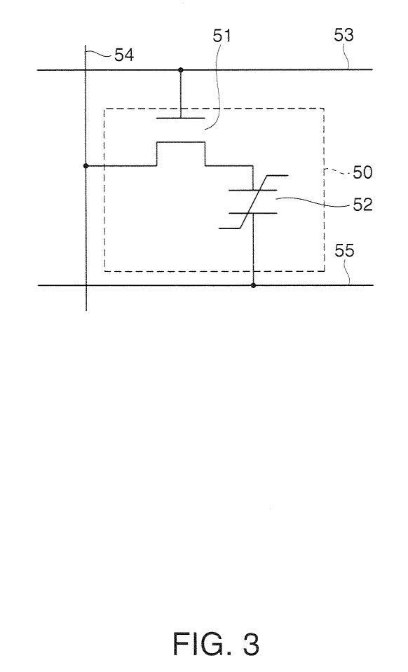

FIG. 3 shows a diagram of a memory cell 50 that forms the FeRAM 5. As shown in the figure, the memory cell 50 is comprised of a transistor 51 and a ferroelectric capacitor 52 formed from a ferroelectric film. The transistor 51 has a gate terminal connected to a word line (WL) 53, a drain terminal (or a source terminal) connected to a bit line (BL) 54, and a source terminal (or a drain terminal) connected to one of the terminals of the ferroelectric capacitor 52. The other terminal of the ferroelectric capacitor 52 is connected to a plate line (PL) 55.

Next, operations of writing data to the memory cell 50 are described. When a predetermined voltage (Vcc) is applied across the two terminals of the ferroelectric capacitor 52, data “1” or “0” is written in the memory cell 50. For example, when the WL 53 is placed in a selection state (in which the transistor 51 is in ON state), the BL 54 is set at 0V, and Vcc is applied to the PL 55, data “0” is written in the memory cell 50. When Vcc is applied to the BL 54, and the PL 55 is set to 0V, data “1” is written in the memory cell 50. Also, the memory cell 50 continues retaining data written even when the WL 53 becomes a non-selection state (in which the transistor 51 is in OFF state).

Next, operations to read out data written in the memory cell 50 are described. The memory cell 50 is equipped with a sense amplifier circuit (not shown). When the BL 54 is set to an open state (0V), the WL 53 is set to a selection state, and Vcc is applied to the PL 55, a predetermined voltage is supplied through the BL 54 to the sense amplifier circuit. The sense amplifier circuit is supplied with different voltages according to the polarization state of the ferroelectric capacitor 52, and performs amplification based on each of the voltages. According to the voltage after amplification by the sense amplifier circuit, data “1” or “0” is read out from the memory cell 50.

When data “1” is read out in the data readout operation, the memory cell 50 performs a destructive readout operation through inverting the polarization of the ferroelectric capacitor 52 from the state of “1” to “0.” The memory cell 50 is controlled to perform a rewriting operation through rewriting data “1” again after the data “1” has been read out, for maintaining the polarization of the ferroelectric capacitor 52 in the state “1.” At this time, the memory cell 50 is controlled by the control section 16 of the reception device 10 such that the rewriting operation is to be performed only upon confirming that the normal procedure is secured after the destructive readout operation. Accordingly, if the second encryption key K2 stored in the storage section 12 of the FeRAM 5 has been read out from the FeRAM 5, the control section 16 does not perform a rewriting operation, as it cannot be confirmed if the normal procedure is secured. As a result, the second encryption key K2 remains in the state of being erased.

The FeRAM 5 performs rewriting operations after destructive readout operations, using a high-speed execution performance equivalent to that of an ordinary volatile memory (for example, SRAM, DRAM and the like). Furthermore, the FeRAM 5 has 10¹⁰ times or more of rewriting durability.

Operations of Reception Device and Remote Control Key

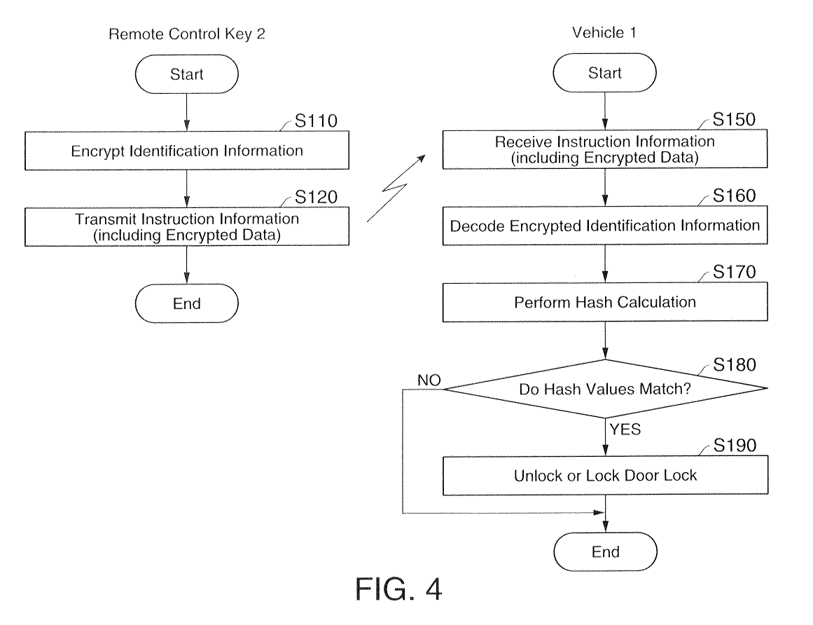

Next, operations of the reception device 10 and the remote control key 2 are described. FIG. 4 is a flowchart of operations of the reception device 10 mounted on the vehicle 1 and the remote control key 2.

First, when an operation button is operated by the user on the remote control key 2 shown in the figure, the encryption section 23 of the remote control key 2 encrypts the identification information for the remote control key 2, using the first encryption key K1 stored in the storage section 22, in step S110. The operation button may include two kinds of buttons, a vehicle door unlocking button and a vehicle door locking button.

In step S120, the transmission section 21 of the remote control key 2 transmits to the vehicle 1 instruction information containing the identification information encrypted in step S110 and control information that is generated according to the operation of the operation button.

Next, on the side of the vehicle 1, in step S150, the reception section 11 of the reception device 10 receives the instruction information transmitted from the remote control key 2.

In step S160, the decoding section 13 of the reception device 10 decodes the encrypted identification information contained in the instruction information received in step S150, using the second encryption key K2 stored in the storage section 12.

In step S170, the judgment section 14 of the reception device 10 calculates two hash values of the identification information of the remote control key 2 which is decoded in step S160 and the identification information stored in the ROM of the control section 16 of the reception device 10.

In step S180, the control section 16 of the reception device 10 judges as to whether the two hash values calculated in step S170 match. When the hash values match with each other, in other words, when the remote control key 2 matches with the reception device 10, the process proceeds to step S190 wherein the door lock control section 15 of the reception device 10 controls to unlock or lock the door lock on the vehicle 1. On the other hand, when the hash values do not match, in other words, when the remote control key 2 does not match with the reception device 10, the process is finished without unlocking or locking the door lock.

Effects

As described above, according to the vehicle security system in accordance with the present embodiment, the storage section 12, the decoding section 13 and the judgment section 14 of the reception device 10 are formed from the FeRAM 5. Also, the memory cell 50 forming the FeRAM 5 is controlled to perform a rewriting operation only upon confirming that the normal procedure is secured after a destructive readout operation. Therefore, if the second encryption key K2 stored in the storage section 12 is read out from the FeRAM 5, the second encryption key K2 assumes a state of being erased. Accordingly, even when an unauthorized user with malicious intention reads out the second encryption key K2 from the FeRAM 5, and illegally creates a remote control key having the first encryption key K1 based on the second encryption key K2, encrypted identification information sent from the remote control key cannot be decoded by the reception device 10. As a result, the unauthorized user with malicious intention cannot unlock or lock the door lock on the vehicle 1 by using the illegally created remote control key.

Also, the decoding section 13 and the judgment section 14 are also formed from the FeRAM 5, which makes it difficult for unauthorized users with malicious intention to analyze the algorithms for decoding process, judgment process and the like, whereby the confidentiality concerning the encryption technology can be improved.

Also, the FeRAM 5 is capable of high-speed rewriting, and has 10¹⁰ times or more of rewriting durability. As a result, the quality guarantee in commercial and actual use can be secured for the vehicle security system having the FeRAM 5 that performs a rewriting operation only upon confirming the correct procedure after a destructive readout operation.

### Second Embodiment

A vehicle security system in accordance with a second embodiment of the invention is described below with reference to the accompanying drawings.

Vehicle and Immobilizer Key

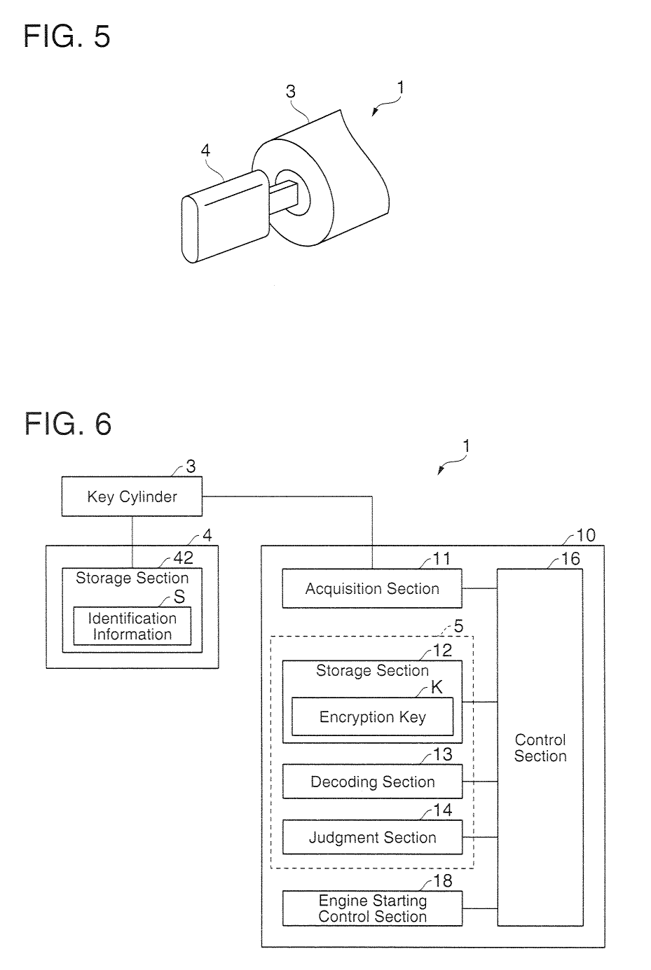

FIG. 5 is a schematic illustration of an immobilizer key for starting an engine mounted on the vehicle and a key cylinder 3 that receives the immobilizer key 4, in accordance with a second embodiment. As shown in the figure, the immobilizer key 4 is inserted from outside of the vehicle 1 by the user in the key cylinder 3 provided on the vehicle 1. The immobilizer key 4 is connected to a reception device 10 mounted on the vehicle 1 through the key cylinder 3. More specifically, an example of the vehicle security system in accordance with the present embodiment is formed from the reception device 10 mounted on the vehicle 1 and the immobilizer key 4. The immobilizer key 4 enables starting of the engine of the vehicle 1 only when it is judged to be authentic, and plays a role to prevent theft of the vehicle 1. Also, the vehicle 1 is in a stopped state, and the engine mounted on the vehicle 1 is also in a stopped state.

FIG. 6 is a block diagram of functional compositions of the reception device 10 installed on the vehicle 1 and the immobilizer key 4. As shown in the figure, the reception device 10 includes an acquisition section 11, a storage section 12, a decoding section 13, a judgment section 14, an engine starting control section 18 as a vehicle control section, and a control section 16. The immobilizer key 4 is in a state connected to the reception device 10 through the key cylinder 3, and the immobilizer key 4 has a storage section 42. Further, the storage section 12 of the reception device 10 stores an encryption key K. The storage section 42 of the immobilizer key 4 stores encrypted identification information S that identifies the immobilizer key 4.

Here, the storage section 12, the decoding section 13 and the judgment section 14 of the reception device 10 are formed from a FeRAM 5, lake the first embodiment. It is noted that not all of the storage section 12, the decoding section 13 and the judgment section 14 may be composed of a FeRAM 5, but at least the encryption key K stored in the storage section 12 may be formed from the FeRAM 5.

Next, functions of the reception device 10 are described. The acquisition section 11 of the reception device 10 acquires the encrypted identification information S for identifying the immobilizer key 4 from the storage section 42 of the immobilizer key 4.

The judgment section 14 of the reception device 10 judges, based on the identification information S of the immobilizer key 4 decoded by the decoding section 13, as to whether the immobilizer key 4 can match with the reception device 10. Here, hash values of the decoded identification information S of the immobilizer key 4 and the identification information stored in the ROM of the control section 16 (to be described below) are calculated, and the two hash values are compared to make the judgment.

The engine starting control section 18 of the reception device 10 controls starting of the engine of the vehicle 1 when the judgment section 14 judges that the immobilizer key 4 can match.

The control section 16 of the reception device 10 is equipped with unshown CPU, ROM, RAM and the like, and controls each of the aforementioned acquisition section 11, the storage section 12, the decoding section 13, the judgment section 14 and the engine starting control section 18.

Operation of Reception Device and Immobilizer Key

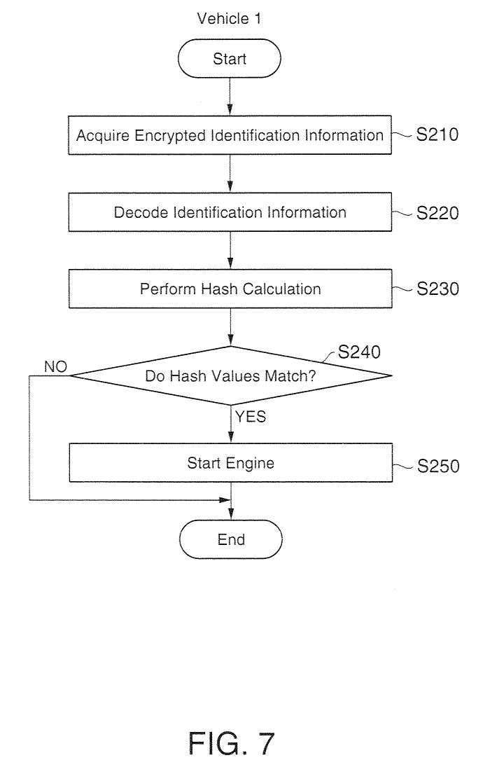

Next, operations of the reception device 10 and the immobilizer key 4 are described. FIG. 7 is a flowchart of operations of the reception device 10 and the immobilizer key 4.

First, when the user conducts an engine starting operation by inserting the immobilizer key 4 in the key cylinder 3 of the vehicle 1, the acquisition section 11 of the reception device 10 acquires the encrypted identification information S from the storage section 42 of the immobilizer key 4, in step S210.

In step S220, the decoding section 13 of the reception device 10 decodes the encrypted identification information S obtained in step S210, using the encryption key K stored in the storage section 12.

In step S230, the judgment section 14 of the reception device 10 calculates two hash values of the identification information S of the immobilizer key 4 decoded in step S220 and the identification information stored in the ROM of the control section 16 of the reception device 10.

In step S240, the control section 16 of the reception device 10 judges as to whether the two hash values calculated in step S230 match with each other. When the hash values match, in other words, when the immobilizer key 4 matches with the reception device 10, the process proceeds to step S250, wherein the engine starting control section 18 of the reception device 10 controls to start the engine of the vehicle 1. On the other hand, when the hash values do not match, in other words, the immobilizer key 4 does not match with the reception device 10, the process is finished without starting the engine of the vehicle 1.

Effects

As described above, according to the vehicle security system in accordance with the second embodiment, the storage section 12, the decoding section 13 and the judgment section 14 of the reception device 10 are formed from the FeRAM 5. Also, the memory cell 50 forming the FeRAM 5 is controlled to perform a rewriting operation only upon confirming that the normal procedure is secured after a destructive readout operation. Therefore, if the encryption key K stored in the storage section 12 is read out from the FeRAM 5, the encryption key K assumes a state of being erased. Accordingly, even when an unauthorized user with malicious intention reads out the encryption key K from the FeRAM 5, and illegally creates an immobilizer key based on the encryption key K, encrypted identification information provided from the immobilizer key cannot be decoded by the reception device 10. As a result, the unauthorized user with malicious intention cannot start the engine of the vehicle 1 by using the illegally created immobilizer key.

It is noted that, in the embodiments described above, examples of vehicle security systems that control door locks and starting of an engine of a vehicle are described. However, the invention is not limited to the control of door locks and starting of an engine of a vehicle, but is also applicable to various other systems for vehicles.

What is claimed is:

1. A vehicle security system comprising:
a reception device that is mounted on a vehicle; and
a transmission device that remotely operates the vehicle, wherein
the transmission device includes
an encryption section that encrypts identification information that identifies the transmission device with a first encryption key, and
a transmission section that transmits to the reception device instruction information that includes the identification information encrypted and gives an operation instruction to the reception device, and
the reception device includes
a FeRAM that stores a second encryption key to pair with the first encryption key, wherein the second encryption key is erased from the FeRAM when the second encryption key is read out from the FeRAM,
a reception section that receives the instruction information transmitted from the transmission device,
a decoding section that decodes the identification information received, which is encrypted with the first encryption key and included in the instruction information received, with the second encryption key that is supposed to be stored in the FeRAM, and
a judgment section that judges based on the decoded identification information as to whether the transmission device matches with the reception device.

2. A vehicle security system according to claim 1, wherein the instruction information transmitted from the transmission device includes control information for controlling the vehicle on which the reception device is mounted, the reception device further includes a vehicle control section that controls the vehicle, wherein, when the judgment section judges that the transmission device matches with the reception device, the vehicle control section controls the vehicle based on the control information included in the instruction information received by the reception section.

3. A vehicle security system according to claim 2, wherein the control information is information to control a door lock on the vehicle.

4. A vehicle security system according to claim 2, wherein the control information is information to control starting of an engine of the vehicle.

5. A vehicle security system comprising:
a reception device that is mounted on a vehicle; and
an immobilizer key to be inserted in the vehicle, wherein
the immobilizer key includes
a storage section that stores encrypted identification information for identifying the immobilizer key, and
the reception device includes
a FeRAM that stores an encryption key, wherein the encryption key is erased from the FeRAM when the encryption key is read out from the FeRAM,
an acquiring section that acquires the encrypted identification information from the storage section of the immobilizer key,
a decoding section that decodes the encrypted identification information acquired by using the encryption key that is supposed to be stored in the FeRAM, and
a judgment section that judges based on the decoded identification information as to whether the immobilizer key matches with the reception device.
